(19) United States
(12) Patent Application Publication
(10) Pub. No.: US 2025/0350190 A1
(43) Pub. Date: Nov. 13, 2025

(54) INTEGREATED CONTROL CIRCUIT WITH TRANSMISSION TERMINAL FOR MULTI-CONVERTER SWITCHING POWER SUPPLY

(71) Applicant: Chengdu Monolithic Power Systems Co., Ltd., Chengdu (CN)

(72) Inventors: Xuefeng Chen, Hangzhou (CN); Hantao Lin, Hangzhou (CN); Hui Li, Hangzhou (CN)

(21) Appl. No.: 19/202,639

(22) Filed: May 8, 2025

(30) Foreign Application Priority Data
May 9, 2024 (CN) 202410572284.5

(51) Int. Cl. H02M 1/088; H02M 3/335

(52) U.S. Cl. CPC H02M 1/088; H02M 3/33576

(57) ABSTRACT

An integrated control circuit for switching converter in a multi-converter switching power supply. The integrated control circuit has a transmission terminal for receiving an enable signal indicating that the multi-converter switching power supply operates in a first or a second power supply mode. In the first power supply mode, the integrated control circuit as a master control circuit provides a control signal to control the switching converter based on a feedback signal representing an output voltage, and the transmission terminal of the master control circuit provides a time indication pulse signal to a transmission terminal of a slave control circuit. The integrated control circuit as the salve control circuit receives the time indication pulse signal from the transmission terminal of the master control circuit and provides the control signal to control the switching converter based on the time indication pulse signal.

### CROSS-REFERENCE TO RELATED APPLICATIONS

This application claims the benefit of CN application 202410572284.5, filed on May 9, 2024, and incorporated herein by reference.

### TECHNICAL FIELD

The present invention generally relates to electronic circuits, and more particularly but not exclusively, to multi-converter switching power supply with communication function and associated control methods.

### BACKGROUND

In the power conversion applications with multi-output PD (Power Delivery) adapters, one or more PD controllers may be coupled to each USB (Universal Serial Bus) port for detecting the load configuration on the USB ports, and the detected load configuration is provided to integrated control circuits for controlling switching converters to provide power for the load, to meet variable power requirements. However, the communication between the PD controllers coupled to the USB ports and the integrated control circuits may require serial communication interfaces, such as SPI, I2C, etc. This results in increasing of I/O pin count of the integrated control circuits, an expansion of PCB size and/or an increase in the cost. In addition, if a dedicated communication interface is used and embedded in the integrated control circuit, a certain amount of processing memory may need to be increased, this introduces the product design challenges owing to the limited memory capacity and die area, and this may require a longer product development timeline due to the complexity of the product.

### SUMMARY

There has been provided, in accordance with an embodiment of the present disclosure, a multi-converter switching power supply. The multi-converter switching power supply comprises a first switching converter, a second switching converter, a first integrated control circuit and a second integrated control circuit. The first switching converter is configured to provide a first output voltage to a first output terminal and a second output terminal. The second switching converter is configured to provide a second output voltage to a third output terminal and a fourth output terminal. The second output terminal is coupled to the fourth output terminal. The first integrated control circuit is configured to control a first switch of the first switching converter and has a first transmission terminal capable of receiving an enable signal. The enable signal has a logic high state and a logic low state. The enable signal indicates that the multi-converter switching power supply operates in a first power supply mode or a second power supply mode. The second integrated control circuit is configured to control a second switch of the second switching converter and has a second transmission terminal capable of receiving the enable signal. The second transmission terminal is coupled to the first transmission terminal and is configured to receive a time indication pulse signal provided at the first transmission terminal. The second switch is controlled based on the time indication pulse signal when the multi-converter switching power supply operates in the first power supply mode.

There also has also been provided, in accordance with an embodiment of the present disclosure, an integrated control circuit for a switching converter in a multi-converter switching power supply. The integrated control circuit comprises a transmission terminal capable of receiving an enable signal. The enable signal has a logic high state and a logic low state. The enable signal indicates that the multi-converter switching power supply operates in a first power supply mode or a second power supply mode. When the multi-converter switching power supply operates in the first power supply mode and the integrated control circuit is configured as a master control circuit, the master control circuit is configured to provide a control signal to control the switching converter based on a feedback signal representing an output voltage of the switching converter. The transmission terminal is configured to provide a time indication pulse signal to a transmission terminal of a slave control circuit. When the multi-converter switching power supply operates in the second power supply mode and the integrated control circuit is configured as the salve control circuit, the slave control circuit is configured to receive the time indication pulse signal from the transmission terminal of the master control circuit, and to control the switching converter based on the time indication pulse signal.

There has also been provided, in accordance with an embodiment of the present disclosure, a control method used in a multi-converter switching power supply. The control method comprises the flowing actions. A first integrated control circuit is engaged to control a first switching converter to provide a first output voltage to a first output terminal and a second output terminal. A second integrated control circuit is engaged to control a second switching converter to provide a second output voltage to a third output terminal and a fourth output terminal. An enable signal having a logic high state and a logic low state is received and the enable signal indicates that the multi-converter switching power supply operates in a first power supply mode or a second power supply mode. One of the first integrated control circuit and the second integrated control circuit is configured as a master control circuit and the other of the first integrated control circuit and the second integrated control circuit is configured as a slave control circuit when entering the first power supply mode is identified. A control signal to control the corresponding switching converter is provided by the master control circuit, based on a feedback signal representing an output voltage of the corresponding converter. A time indication pulse signal at a transmission terminal of the master control circuit is sent to a transmission terminal of the slave control circuit. The time indication pulse signal from the mater control circuit is received by the salve control circuit and the switching converter corresponding to the slave control circuit is controlled based on the time indication pulse signal.

### BRIEF DESCRIPTION OF DRAWINGS

The present invention can be further understood with reference to the following detailed description and the appended drawings, wherein like elements are provided with like reference numerals.

FIG. 1 schematically illustrates a block diagram of a multi-converter switching power supply 100 in accordance with an embodiment of the present invention.

FIG. 2 schematically illustrates a working waveform diagram of a signal IO in accordance with an embodiment of the present invention.

FIG. 3 schematically illustrates a circuit diagram of a multi-converter switching power supply 100A in accordance with an embodiment of the present invention.

FIG. 4 shows a flow diagram of a control method 300 for the multi-converter switching power supply in accordance with an embodiment of the present invention.

FIG. 5 shows a working waveform diagram of the multi-converter switching power supply 100A operating in a first power supply mode in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

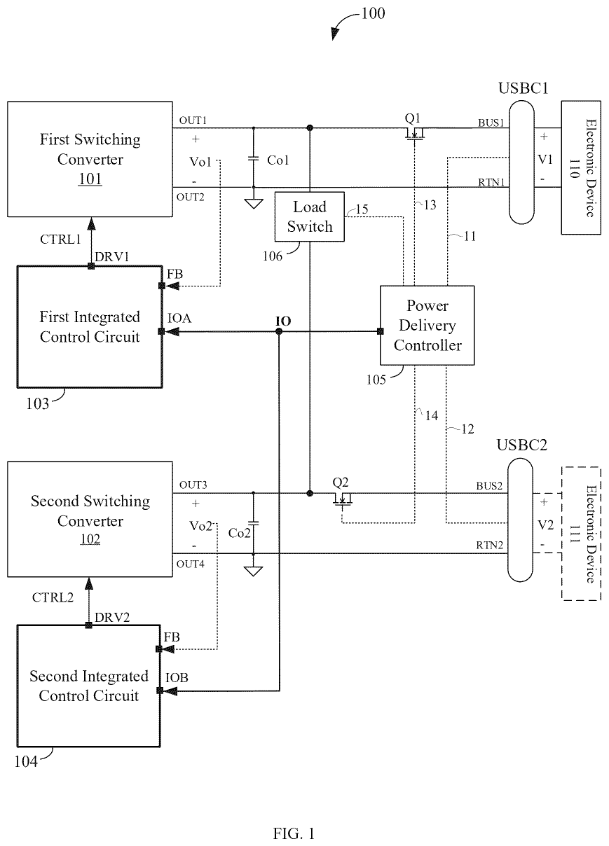

FIG. 1 schematically illustrates a block diagram of a multi-converter switching power supply 100 in accordance with an embodiment of the present invention. For ease of description and understanding, the switching power supply 100 is illustrated to support dynamic power management between two USB ports (exemplarily illustrated as USBC1 and USBC2). However, this is not intended to be limiting. In one embodiment, the multi-converter switching power supply 100 may be configured to support three or more USB ports.

In the embodiment shown in FIG. 1, the multi-converter switching power supply 100 comprises a first switching converter 101, a second switching converter 102, a first integrated control circuit 103, a second integrated control circuit 104, and a power delivery (PD) controller 105, a load switch 106, a first USB port (USBC1), and a second USB port (USBC2).

As shown in FIG. 1, the first switching converter 101 has a first output terminal OUT1 and a second output terminal OUT2. The first switching converter 101 is configured to provide a first output voltage Vo1 to the first output terminal OUT1 and the second output terminal OUT2. The second switching converter 102 has a third output terminal OUT3 and a fourth output terminal OUT4. The second switching converter 102 may be configured to provide a second output voltage Vo2 to the third output terminal OUT3 and the fourth output terminal OUT4. The second output terminal OUT2 is coupled to the fourth output terminal OUT4 and they are grounded together.

To filter ripple and stabilize the output voltages Vo1 and Vo2, both output terminals of the first switching converter 101 and the second switching converter 102 are coupled to a respective output capacitor. As shown in FIG. 1, an output capacitor Co1 is coupled between the first output terminal OUT1 and the second output terminal OUT2 of the first switching converter 101 to receive the first output voltage Vo1. An output capacitor Co2 is coupled between the third output terminal OUT3 and the fourth output terminal OUT4 of the second switching converter 102 to receive the second output voltage Vo2. Considering capacity, price and volume, the output capacitors Co1 and Co2 are generally made of electrolytic capacitors, such as aluminum electrolytic capacitors.

In the example shown in FIG. 1, the first USB port USBC1 has a bus terminal BUS1 and a ground terminal RTN1, and the bus terminal BUS1 is configured to receive a first voltage V1 and the ground terminal RTN1 is coupled to ground. The second USB port USBC2 has a bus terminal BUS2 and a ground terminal RTN2, and the bus terminal BUS2 is configured to receive a second voltage V2 and the ground terminal RTN2 is coupled to ground. In some practical applications, at least one USB port is not connected to an external electronic device. For example, only the first port USBC1 is coupled to a first electronic device 110 and the second USB port USBC2 is disconnected from a second electronic device 111 (i.e., the second USB port USBC2 is floating). Thus, as shown in FIG. 1, an open connection of the second USB port USBC2 to the second electronic device 111 is illustrated with dashed line. In one embodiment, the first USB port USBC1 and the second USB port USBC2 may be both configured as USB Type-C ports. However, this is not intended to be limiting.

To provide an example, the power delivery controller 105 may be configured to control selection switches Q1 and Q2 and the load switch 106 in accordance with the detection of power requirements of USB ports USBC1 and USBC2, and to provide power sharing function to support the dynamic power management among these USB ports. As a result, various power requirements for different loads can be met. In the example shown in FIG. 1, the selection switch Q1 is coupled between the first output terminal OUT1 and the bus terminal BUS1, and the selection switch Q2 is coupled between the third output terminal OUT3 and the bus terminal BUS2.

The power delivery controller 105 is coupled to the first USB port USBC1 and the second USB port USBC2 via wires 11 and 12 respectively. The power delivery controller 105 is configured to determine whether the switching power supply 100 to operate in a first power supply mode or a second power supply mode, and to provide an enable signal IO at a communication terminal. The enable signal IO may be adapted to be transmitted to the first integrated control circuit 103 and the second integrated control circuit 104 when the communication terminal of the power delivery controller 105 is coupled to the first integrated control circuit 103 and the second integrated control circuit 104.

When only the first USB port USBC1 is coupled to the first electronic device 110 while the second USB port USBC2 is disconnected from the second electronic device 111, and the first switching converter 101 can not provide enough output power to meet the power requirement of the first electronic device 110, the power delivery controller 105 is configured to enable the first power supply mode of the multi-converter switching power supply 100, for example, by pulling down a logic state of the enable signal IO for a first time threshold.

When the first USB port USBC1 is coupled to the first electronic device 110 while the second USB port USBC2 is also connected to the second electronic device 111, the second power supply mode of the multi-converter switching power supply 100 will be asserted, for example, by firstly pulling down the logic state of the enable signal IO for a second time threshold and then keeping the logic state of the enable signal IO to be high. In one example, the second time threshold is longer than the first time threshold.

When the multi-converter switching power supply operates in the first power supply mode, the load switch 106 coupled between the first output terminal OUT1and the third output terminal OUT3 is turned on, and the selection switch Q1 coupled between the first output terminal OUT1 and the bus terminal BUS1 is turned on. In this case, the first output terminal OUT1 and the third output terminal OUT3 are both coupled to the bus terminal BUS1 of the first USB port USBC1, and the first switching converter 101 and the second switching converter 102 are configured to provide the first voltage V1 for sourcing the bus terminal BUS1 together, thereby providing double current load capability to the first electronic device 110.

In the example shown in FIG. 1, the first switching converter 101 and the second switching converter 102 could have the same topology. In one embodiment, both the first switching converter 101 and the second switching converter 102 are flyback converters. In other embodiments, the first switching converter 101 and the second switching converter 102 may also be implemented using any other suitable topology, such as Forward, Half-bridge flyback, Asymmetrical half-bridge configuration, and so on.

In the example shown in FIG. 1, the first switching converter 101 and the second switching converter 102 are controlled by the first integrated control circuit 103 and the second integrated control circuit 104, respectively. In one embodiment, the first integrated control circuit 103 may have a feedback terminal FB that is configured to receive a first feedback signal VFB1 related to the first output voltage Vo1. The first integrated control circuit 103 is configured to provide a first control signal CTRL1 for controlling a first switch of the first switching converter 101 in accordance with the first feedback signal VFB1. The second integrated control circuit 104 is configured to provide a second control signal CTRL2 for controlling a second switch of the second switching converter 102.

In one embodiment, the first integrated control circuit 103 and the first switch of the first switching converter 101 may be integrated in a single integrated circuit (IC). In an example, the first switch is configured as a power switch of the first switching converter 101. In another example, the first switch comprises a secondary switch disposed at a secondary side of the first switching converter 101. Similarly, in an example, the second integrated control circuit 104 and the second switch can be integrated in a same package. In an example, the second switch is configured as a power switch of the second switching converter 102. In another example, the second switch comprises a secondary switch disposed at a secondary side of the second switching converter 102.

In the example shown in FIG. 1, the first integrated control circuit 103 has a transmission terminal IOA. The transmission terminal IOA is coupled to the communication terminal of the PD controller 105 and may be capable of receiving the enable signal IO provided by the PD controller 105. The first integrated control circuit 103 is configured to identify the entering the first power supply mode of the multi-converter switching power supply based on the logic state of the enable signal IO. Similarly, the second integrated control circuit 104 has a transmission terminal IOB. The transmission terminal IOB is coupled to the communication terminal of the PD controller 105 and may be capable of receiving the enable signal IO provided by the PD controller 105. The second integrated control circuit 104 is configured to identify the entering the first power supply mode of the multi-converter switching power supply 100 based on the logic state of the enable signal IO. In addition, the transmission terminal IOB of the second integrated control circuit 104 is coupled to the transmission terminal IOA of the first integrated control circuit 103. When the multi-converter switching power supply 100 operates in the first power supply mode, the second integrated control circuit 104 is configured to provide the second control signal CTRL2 to control the second switch based on a time indication pulse signal at the transmission terminal IOA. However, when the multi-converter switching power supply 100 operates in the second power supply mode, the second integrated control circuit 104 is configured to provide the second control signal CTRL2 to control the second switch based on a second feedback signal VFB2 received at a feedback terminal FB of the second integrated control circuit 104. The second feedback signal VFB2 is representative of the second output voltage Vo2.

When the multi-converter switching power supply 100 operates in the second power supply mode, the load switch 106 coupled between the first output terminal OUT1 and the third output terminal OUT3 is turned off, the selection switch Q1 coupled between the first output terminal OUT1 and the bus terminal BUS1 remains on, and the selection switch Q2 coupled between the third output terminal OUT3 and the bus terminal BUS2 is turned on. In such situation, the third output terminal OUT3 is decoupled from the bus terminal BUS1 and the first output terminal OUT1. And then the third output terminal OUT3 is coupled to the bus terminal BUS2 of the second USB port USBC2. The first integrated control circuit 103 is configured to control the first switching converter 101 to provide the first output voltage Vo1 based on the first feedback signal VFB1, to provide power to the first electronic device 110. The first output voltage Vo1 is provided as the first voltage V1 supplied to the first USB port USBC1. At the same time, the second integrated control circuit 104 is configured to control the second switching converter 102 to provide the second output voltage Vo2 based on the second feedback signal VFB2, to provide power to the second electronic device 111. The second output voltage Vo2 is provided as the second voltage V2 supplied to the second port USBC2.

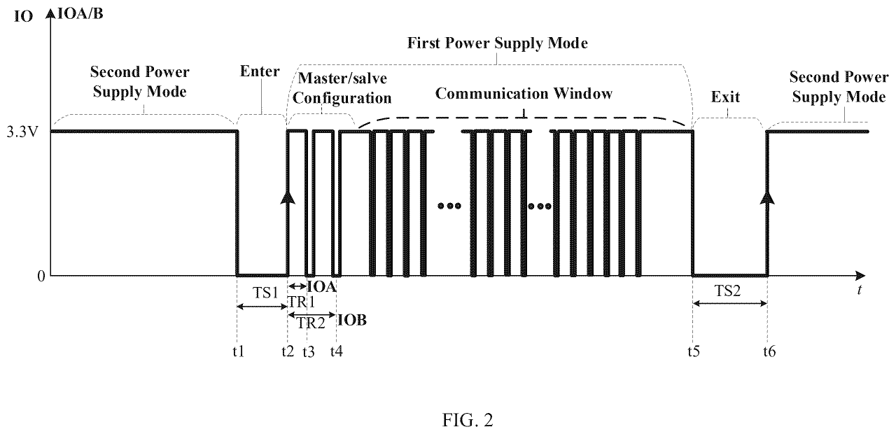

FIG. 2 schematically illustrates a working waveform diagram of a signal IO in accordance with an embodiment of the present invention. It is noted that, for ease of description and understanding, the signal IO is referred as the enable signal IO outside a communication window, while the signal IO is referred as the time indication pulse signal during the communication window.

As shown in FIG. 2, before time t1, there is no communication between the transmission terminal IOA and the transmission terminal IOB. The signal IO is function as the enable signal with logic high, which indicates that the multi-converter switching power supply 100 operates in the second power supply mode. The PD controller 105 shown in FIG. 1 determines to change from the second power supply mode to the first power supply mode. After time t1, the communication terminal of the PD controller 105 is pulled down to the logic low state for a first time threshold TS1, to indicate the entering of the first power supply mode. In the example shown in FIG. 2, from t1 to t2, entering the first power supply mode is identified by the first integrated control circuit 103 and the second integrated control circuit 104 in response to the duration of the logic low state of the enable signal IO reaching the first time threshold TS1. In an embodiment, the first time threshold TS1 is not shorter than 50 μs and is not loner than 500 ms.

Referring still to FIG. 2, after the identification of entering the first power supply mode, the first integrated control circuit 103 and the second integrated control circuit 104 will respond the PD controller 105. In detail, the first integrated control circuit 103 is configured to start timing from a first transition edge (i.e., time t2, change from the logic low state to the logic high state of the enable signal IO) after the identification of entering the first power supply mode, and is further configured as a master control circuit by providing a first pulse signal at time t3 in response to the timing duration exceeding a first timing period TR1, as a response to the PD controller 105. The second integrated control circuit 104 is configured to start timing from the first transition edge (i.e., time t2) of the enable signal IO after the identification of entering the first power supply mode, and is further configured as a slave control circuit by providing a second pulse signal at time t4 in response to the timing duration exceeding a second timing period TR2, as a response to the PD controller 105.

From time t4, the communication window starts, the communication between the first integrated control circuit 103 and the second integrated control circuit 104 is enabled. In detail, during the communication window, the first integrated control circuit 103 is configured to send the time indication pulse signal IO at the transmission terminal IOA, to the transmission terminal IOB of the second integrated control circuit 104. The time indication pulse signal IO is related to the first control signal CTRL1. The time indication pulse signal IO has a first level and a second level. The second integrated control circuit 104 is configured to provide the second control signal CTRL2 to control the second switch of the second switching converter 102 based on the time indication pulse signal IO. The first level width of the time indication pulse signal IO indicates that a time difference between a start point when a voltage across the first switch reaches a plateau voltage and a stop point when a current flowing through the first switch crossing zero. The switching cycle period T_{SW1} of the time indication pulse signal IO indicates that a time interval between two consecutive start points.

From time t5, the PD controller 105 shown in FIG. 1 determines to exit the first power supply mode and to return the second power supply mode, based on the conditions of the first USB port USBC1 and the second USB port USBC2, the PD controller 105 is configured to pull down the enable signal IO for a second time threshold TS2, the communication window ends. In one embodiment, exiting the first power supply mode is identified by the integrated control circuits 103 and 104 in response to the duration of the logic low state of the enable signal IO reaching the second time threshold TS2. In an example, the second time threshold TS2 is longer than the first time threshold TS1.

After time t6, the multi-converter switching power supply 100 operates in the second power supply mode, there is no longer communication between the first integrated control circuit 103 and the second integrated control circuit 104. The enable signal IO remains logic high. The second integrated control circuit 104 is configured to provide the second control signal CTRL2 based on the second feedback signal VFB2 in the second power supply mode.

The embodiment shown in FIG. 2 can be used to configure the first integrated control circuit 103 as the master control circuit and to configure the second integrated control circuit 104 as the slave control circuit. However, this is not intended to be limiting. In one embodiment, the configuration of the master control circuit and the slave control circuit can use other ways. For example, the first integrated control circuit 103 can be configures as the master control circuit by connecting a configuration terminal of the first integrated control circuit 103 to ground, and the second integrated control circuit 104 may be configured as the slave control circuit by floating a configuration terminal of the second integrated control circuit 104. The embodiments shown in FIG. 2 may not only save the terminals for configuration, but also perform the communication among the PD controller 105, the first and second integrated control circuit 103 and 104, and thus more efficient than the solution with the dedicated terminals for configuration.

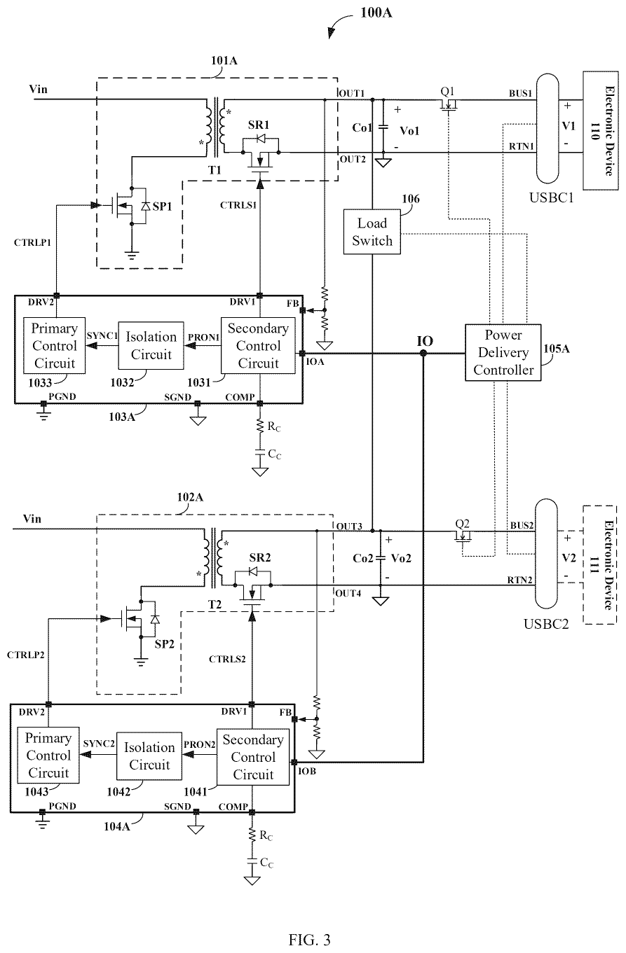

FIG. 3 schematically illustrates a circuit diagram of a multi-converter switching power supply 100A in accordance with an embodiment of the present invention. In the embodiment shown in FIG. 3, the first switching converter 101A and the second switching converter 102A are both flyback. The first switching converter 101A comprises a primary switch SP1, a transformer T1, a secondary switch SR1. The second switching converter 102A comprises a primary switch SP1, a transformer T2 and a secondary switch SR2.

As shown in FIG. 3, the first switching converter 101A comprises a first output capacitor Co1. The second switching converter 102A comprises a second output capacitor Co2. The first switching converter 101A is configured to convert an input voltage Vin into a first output voltage Vo1. The second switching converter 102A is configured to convert the input voltage Vin into a second output voltage Vo2.

In the example shown in FIG. 3, the first integrated control circuit 103A comprises a secondary control circuit 1031, an isolation circuit 1032 and a primary control circuit 1033 and a plurality of terminals. The plurality of terminals comprises a feedback terminal FB, a transmission terminal IOA, a secondary drive terminal DRV1,a compensation terminal COMP, a primary drive terminal DRV2, a secondary reference ground SGND and a primary reference ground PGND. The second integrated control circuit 104A comprises a secondary control circuit 1041, an isolation circuit 1042 and a primary control circuit 1043 and a plurality of terminals including a feedback terminal FB, a transmission terminal IOB, a secondary drive terminal DRV1, a compensation terminal COMP, a primary drive terminal DRV2, a secondary reference ground SGND and a primary reference ground PGND.

In the example shown in FIG. 3, the feedback terminal FB of the first integrated control circuit 103A is coupled to an external voltage divider that is coupled between the first output terminal OUT1 and the second output terminal OUT2. The feedback terminal FB of the first integrated control circuit 103A is configured to receive a first feedback signal VFB1 related to the first output voltage Vo1 via the voltage divider. The compensation terminal COMP is coupled to an external compensation resistor R_{c} and a compensation capacitor C_{c}. A compensation signal is provided at the compensation terminal COMP based on a difference between the first feedback signal VFB1 and a reference voltage. The transmission terminal IOA is configured to receive the enable signal IO that indicates that the multi-converter switching power supply 100A operates in the first power supply mode or the second power supply mode. In one embodiment, entering the first power supply mode is identified in response to a duration of the logic low state of the enable signal IO reaching the first time threshold TS1, and exiting the first power supply mode is identified in response to the duration of the logic low state of the enable signal IO reaching the second time threshold TS2.The second time threshold TS2 is different from the first time threshold TS1.

In an example, after the identification of entering the first power supply mode, one of the first integrated control circuit 103A and the second integrated control circuit 104A as a master control circuit and the other of the first integrated control circuit 103A and the second integrated control circuit 104A is configured as a slave control circuit. In a further embodiment, the first integrated control circuit 103A is configured to start timing from a first transition edge of the enable signal IO after the identification of entering the first power supply mode, and is further configured as the master control circuit by providing a first pulse signal in response to the timing duration exceeding a first timing period TR1. When the first integrated control circuit 103A is configured as the master control circuit, the second integrated control circuit 104A is configured as the slave control circuit in response to the timing duration exceeding the second timing period TR2. The second timing period TR2 is different from the first timing period TR1.

In the first power supply mode of the multi-converter switching power supply, when the first integrated control circuit 103A is configured as the master control circuit, the communication window starts, the secondary control circuit 1031 is configured to provide a control signal CTRLS1 based on the compensation signal at the compensation terminal COMP, and is further to provide the time indication pulse signal IO (during the communication window) to the transmission terminal IOB of the second integrated control circuit 104A configured as the slave control circuit. In the example shown in FIG. 3, the control signal CTRLS1 is provided to the secondary drive terminal DRV1 for controlling the secondary switch SR1.

The secondary control circuit 1031 is further configured to provide a primary enable signal PRON1 bases on the control signal CTRLS1 of controlling the secondary switch SR1. The isolation circuit 1032 has an input terminal configured to receive the primary on enable signal PRON and an output terminal for outputting a synchronous signal SYNC1 electrically isolated from the primary on enable signal PRON1. The primary control circuit 1033 is coupled to the output terminal of the isolation circuit 1032 and is configured to receive the synchronous signal SYNC1 and to provide a primary control signal CTRLP1 to the primary drive terminal DRV2 for controlling the primary switch SP1 at a primary side based on the synchronous signal SYNC1.

In the first power supply mode of the multi-converter switching power supply 200A, when the second integrated control circuit 104A is configured as the slave control circuit, the transmission terminal IOB is configured to receive the time indication pulse signal IO from the transmission terminal IOA of the first integrated control circuit 103A. The secondary control circuit 1041 is configured to provide a control signal CTRLS2 based on the time indication pulse signal IO during the communication window. In the example shown in FIG. 3, the control signal CTRLS2 is provided to the secondary drive terminal DRV1 for controlling the secondary switch SR2.

The secondary control circuit 1041 is further configured to provide a primary enable signal PRON2 bases on the control signal CTRLS2 of controlling the secondary switch SR2. The isolation circuit 1042 has an input terminal configured to receive the primary on enable signal PRON2 and an output terminal for outputting a synchronous signal SYNC2 electrically isolated from the primary on enable signal PRON2. The primary control circuit 1043 is coupled to the output terminal of the isolation circuit 1042 and is configured to receive the synchronous signal SYNC2 and to provide a primary control signal CTRLP2 to the primary drive terminal DRV2 for controlling the primary switch SP2 at a primary side based on the synchronous signal SYNC2.

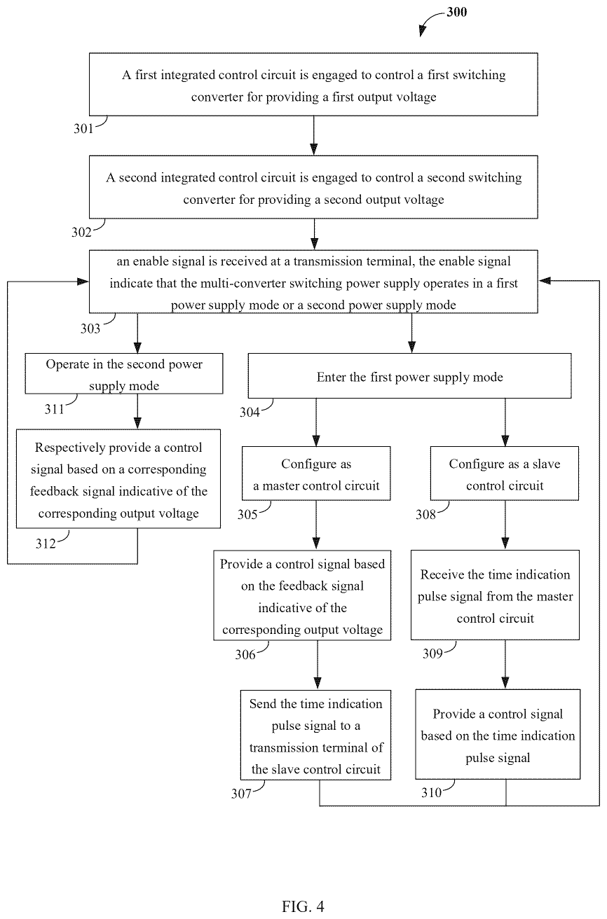

FIG. 4 shows a flow diagram of a control method 300 for the multi-converter switching power supply in accordance with an embodiment of the present invention. In the embodiment shown in FIG. 4, the control method 300 comprises steps 301˜312.

In detail, in step 301, a first integrated control circuit is engaged to control a first switching converter for providing a first output voltage to a first output terminal and a second output terminal.

In step 302, a second integrated control circuit is engaged to control a second switching converter for providing a second output voltage to a third output terminal and a fourth output terminal.

In step 303, an enable signal is received at a transmission terminal of the first integrated control circuit and the second integrated control circuit. The enable signal has a logic high state and a logic low state. The enable signal indicates that the multi-converter switching power supply operates in the first power supply mode or the second power supply mode.

Subsequently, in step 304, entering the first power supply mode is identified, by the first and integrated control circuits, in response to a duration of the logic low state of the enable signal reaching a first time threshold.

In step 305, one of the first and the second integrated control circuits is configured as a master control circuit after entering the first power supply mode is identified. In one embodiment, the configuration of the master control circuit comprises starting timing from a first transition edge of the enable signal after the identification of the first power supply mode and providing a first pulse signal when the timing duration reaches a first timing period.

In step 306, the master control circuit is configured to provide a control signal to control the switching converter corresponding to the master control circuit based on the feedback signal indicative of the corresponding output voltage. In an embodiment, the control signal is coupled to a control terminal of a secondary switch of the switching converter, to control the secondary switch at the secondary side.

In step 307, the master control circuit is configured to send the time indication pulse signal at the transmission terminal to a transmission terminal of the slave control circuit. In an embodiment, the time indication pulse signal is related to the control signal for controlling the secondary switch. In one embodiment, the time indication pulse signal has a first level and a second level. The first level width is configured to represent a time difference between a start point when a voltage across the secondary switch reaches a plateau voltage and a stop point when a current flowing though the secondary switch crosses zero. The time indication pulse signal has a switching cycle period configured to represent a time interval between two consecutive start points.

In step 308, the other of the first and second integrated control circuits is configured as the slave control circuit after entering the first power supply mode is identified. In one embodiment, the configuration of the slave control circuit comprises starting timing from the first transition edge of the enable signal after the identification of the first power supply mode and providing a second pulse signal when the timing duration reaches a second timing period. The second timing period is longer than the first timing period.

In step 309, the time indication pulse signal from the master control circuit is received at a transmission terminal of the slave control circuit.

In step 310, a control signal is provided by the slave control circuit based on the time indication pulse signal.

In one embodiment, exiting the first power supply mode is identified in response to the duration of the logic low state of the enable signal reaching a second time threshold. The second time threshold is longer than the first time threshold.

In step 311, the enable signal remains logic high state indicates the second power supply mode.

In step 312, in the second power supply mode, the first integrated control circuit is configured to control the first switching converter based on a first feedback signal representative of the first output voltage; the second integrated control circuit is configured to control the second switching converter based on a second feedback signal representative of the second output voltage.

In one embodiment, when the multi-converter switching power supply operates in the first power supply mode, the first output terminal and the third output terminal are both coupled to the first bus terminal, the first switching converter and the second switching converter are configured to provide the first voltage to the first bus terminal. When the multi-converter switching power supply operates in the second power supply mode, the first output terminal is coupled to the first bus terminal, the third output terminal is coupled to the second bus terminal, the first output voltage provided by the first switching converter is configured as the first voltage received by the first bus terminal, and the second output voltage provided by the second switching converter is configured as the second voltage received by the second bus terminal.

In one embodiment, when the first USB port USBC1 is coupled to a first electronic device, while the second USB port USBC2 is floating, the multi-converter switching power supply is controlled to operate in the first power supply mode. In the first power supply mode, the first switching converter and the second switching converter may work interleaved or non-interleaved. When the first USB port USBC1 is coupled to the first electronic device and the second USB port USBC2 is coupled to a second electronic device, the multi-converter switching power supply is controlled to operate in the second power supply mode, the first switching converter and the second switching converter may work independently.

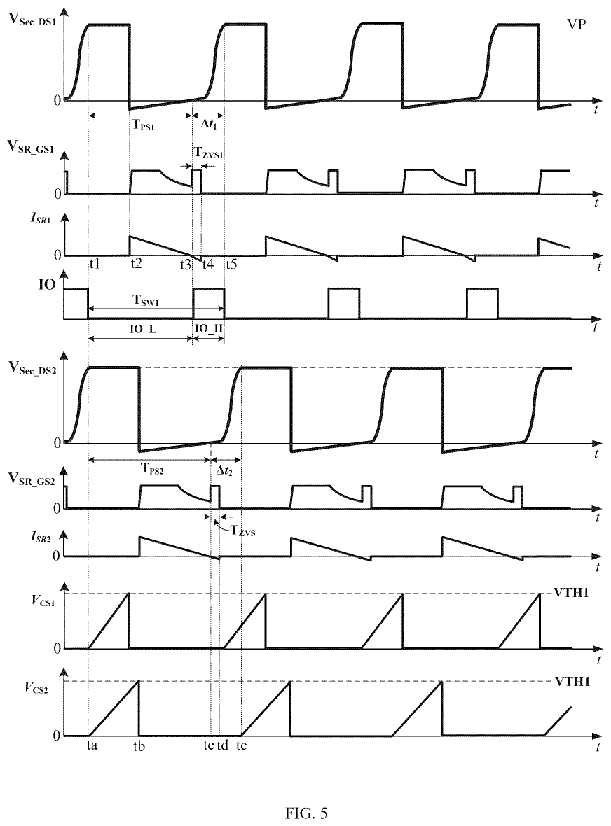

FIG. 5 shows a working waveform diagram of the multi-converter switching power supply 100A operating in a first power supply mode in accordance with an embodiment of the present invention.

As shown in FIG. 5, from top to bottom, the waveforms are a voltage V_{sec_DS1} across the secondary switch SR1, a gate drive voltage V_{SR_GS1} of the secondary switch SR1, a current I_{SR1} flowing through the secondary switch SR1, the time indication pulse signal IO communicated from the transmission terminal IOA to the transmission terminal IOB, a voltage V_{sec_DS2} across the secondary switch SR2, a gate drive voltage V_{SR_GS2} of the secondary switch SR2, a current I_{SR2} flowing through the secondary switch SR2, a first current sense signal V_{CS1} and a second current sense signal V_{CS2}.

As shown in FIG. 5, the secondary switch SR1 at the secondary side is turned on twice in a switching cycle of the first switching converter 101A, to achieve zero-voltage switching (ZVS) turning-on of the primary switch SP1. The secondary switch SR2 is turned on twice in a switching cycle of the second switching converter 102A, to achieve ZVS or nearly ZVS turning on of the primary switch SP2, and at the same time, to meet the power distribution requirements in the first power supply mode. In addition, the first switching converter 101A and the second switching converter 102A can work non-interleaved.

For the first switching converter 101A, as shown in FIG. 5, the primary switch SP1 is turned on from time t1, the current flowing through the primary switch SP1 is increased, the first current sense signal V_{CS1} increases accordingly. The voltage V_{sec_DS1} across the secondary switch SR1 is increased to its plateau voltage (labelled as VP) when the primary switch SP1 is turned on at time t1. The time when the primary switch SP1 is turned on may be referred to as a first start point, and the first start point is determined, the time indication pulse signal IO changes from a second level to a first level.

Referring still to FIG. 5, at time t2, the first current sense signal V_{CS1} increases to a first threshold voltage VTH1, the primary switch SP1 is turned off. The voltage V_{sec_DS1} across the secondary switch SR1 is thus decreased. When the voltage V_{sec_DS1} is decreased to a turn-on threshold voltage, the gate drive voltage V_{SR_GS1} starts to increase, and the secondary switch SR1 is turned on for the first time. When the current I_{SR1} flowing through the secondary switch SR1 decreases to zero at time t3, the secondary switch SR1 is turned off for the first time, and a first stop point is determined. The time when the current flowing through the secondary switch SR1 crosses zero may be referred to as the first stop point. The time indication pulse signal IO changes from the second level to the first level.

In boundary current mode, the secondary switch SR1 is turned on at the boundary point (i.e., time t3), the current I_{SR1} flowing through the secondary switch SR1 becomes negative. After a second ON-time T_{ZVS1}, the secondary switch SR1 is turned off again at time t4. At time t5, the primary switch SP1 is turned on and the new first start point is determined. The new switching cycle of the first switching converter 101A starts.

The time indication pulse signal IO shown in FIG. 5 has the first level and the second level. The first level width IO_L represents a first time difference TPS1 between the first start point (e.g., time t1) when the primary switch SP1 is turned on and the first stop point (e.g., time t3) when the current I_{SR1} crosses zero. The second level width IO_H represents a second time difference Δt1 between the stop point (e.g., time t3) and the next start point (e.g., time t5). The switching cycle period T_{SW1} of the time indication pulse signal IO represents a time interval between two consecutive first start points (e.g., from time t1 to time t5).

For the second switching converter 102A, as shown in FIG. 5, the primary switch SP2 is turned on from time ta, the current flowing through the primary switch SP2 is increased, the second current sense signal V_{CS2} increases accordingly. The voltage V_{sec_DS2} across the secondary switch SR2 is increased to its plateau voltage when the primary switch SP2 is turned on at time ta. The time when the primary switch SP2 is turned on may be referred to as a second start point, and the second start point is determined.

Referring still to FIG. 5, at time tb, the second current sense signal V_{CS2} increases to the first threshold voltage VTH1, the primary switch SP2 is turned off. The voltage V_{sec_DS1} across the secondary switch SR1 is thus decreased. When the voltage V_{sec_DS1} is decreased to a turn-on threshold voltage of the secondary switch SR2, the gate drive voltage V_{SR_GS2} starts to increase, and the secondary switch SR2 is turned on for the first time. When the current I_{SR2} flowing through the secondary switch SR2 decreases to zero at time tc, the secondary switch SR2 is turned off for the first time, and a second stop point is determined. In boundary current mode, the secondary switch SR2 is turned on at the boundary point (i.e., time tc), the current I_{SR2} flowing through the secondary switch SR2 becomes negative. After a second ON-time T_{ZVS}, the secondary switch SR2 is turned off again at time td. At time te, the primary switch SP2 is turned on for a new switching cycle of the second switching converter 102A.

T_{PS2} is a third time difference between the second start point (e.g., time ta) when the primary switch SP2 is turned on and the second stop point (e.g., time tc) when the current flowing through the secondary switch SR2 crosses zero. Δt2 is the fourth time difference between the second stop point (e.g., time tc) and the next second start point (e.g., time te). The second integrated control circuit 104A is configured to adjust the second ON-time T_{ZVS} of the secondary switch SR2, based on the time indication pulse signal IO, the third time difference T_{PS2}, the fourth time difference Δt2, so that the Δt2/Δt1 is close to T_{PS2}/T_{PS1}.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A multi-converter switching power supply, comprising:
a first switching converter configured to provide a first output voltage to a first output terminal and a second output terminal;
a second switching converter configured to provide a second output voltage to a third output terminal and a fourth output terminal;
a first integrated control circuit configured to control a first switch of the first switching converter and having a first transmission terminal capable of receiving an enable signal having a logic high state and a logic low state, wherein the enable signal indicates that the multi-converter switching power supply operates in a first power supply mode or a second power supply mode; and
a second integrated control circuit configured to control a second switch of the second switching converter and having a second transmission terminal capable of receiving the enable signal, wherein the second transmission terminal is coupled to the first transmission terminal to receive a time indication pulse signal provided at the first transmission terminal, and the second switch is controlled based on the time indication pulse signal when the multi-converter switching power supply operates in the first power supply mode.

2. The multi-converter switching power supply of claim 1, wherein entering the first power supply mode is identified in response to a duration of the logic low state of the enable signal reaching a first time threshold.

3. The multi-converter switching power supply of claim 2, wherein:
the first integrated control circuit is configured to start timing from a first transition edge of the enable signal after the identification of entering the first power supply mode, and is further configured as a master control circuit by providing a first pulse signal in response to the timing duration exceeding a first timing period; and
the second integrated control circuit is configured to start timing from the first transition edge of the enable signal after the identification of entering the first power supply mode and is further configured as a slave control circuit by providing a second pulse signal in response to the timing duration exceeding a second timing period, wherein the second timing period is different from the first timing period.

4. The multi-converter switching power supply of claim 1, wherein in the first power supply mode of the multi-converter switching power supply, the time indication pulse signal has a first level and a second level, and the first level width of the time indication pulse signal indicates that a first time difference between a start point when a voltage across the first switch reaches a plateau voltage and a stop point when a current flowing through the first switch crosses zero, and the second level width of the time indication pulse signal indicates that a second time difference between the stop point to a next start point.

5. The multi-converter switching power supply of claim 2, wherein exiting the first power supply mode is identified in response to the duration of the logic low state of the enable signal reaching a second time threshold.

6. The multi-converter switching power supply of claim 1, further comprising:
a first port having a first bus terminal for receiving a first voltage and a first ground terminal coupled to the second output terminal;
a second port having a second bus terminal for receiving a second voltage and a second ground terminal coupled to the fourth output terminal; and
when the multi-converter switching power supply operates in the first power supply mode, the first output terminal and the third output terminal are both coupled to the first bus terminal, the first switching converter and the second switching converter are configured to provide the first voltage to the first bus terminal; and
when the multi-converter switching power supply operates in the second power supply mode, the first output terminal is coupled to the first bus terminal, the third output terminal is coupled to the second bus terminal, the first output voltage is configured as the first voltage received by the first bus terminal, and the second output voltage is configured as the second voltage received by the second bus terminal.

7. The multi-converter switching power supply of claim 6, wherein:
when the first port is coupled to a first electronic device, while the second port is floating, the multi-converter switching power supply is controlled to operate in the first power supply mode; and
when the first port is coupled to the first electronic device and the second port is coupled to a second electronic device, the multi-converter switching power supply is controlled to operate in the second power supply mode.

8. The multi-converter switching power supply of claim 1, wherein the first switch comprises a first secondary switch at a secondary side of the first switching converter, and the second switch comprises a second secondary switch at a secondary side of the second switching converter.

9. An integrated control circuit for a switching converter in a multi-converter switching power supply, the integrated control circuit comprising:
a transmission terminal capable of receiving an enable signal having a logic high state and a logic low state, wherein the enable signal indicates that the multi-converter switching power supply operates in a first power supply mode or a second power supply mode; and
wherein when the multi-converter switching power supply operates in the first power supply mode and the integrated control circuit is configured as a master control circuit, the master control circuit is configured to control the switching converter based on a feedback signal representing an output voltage of the switching converter, and the transmission terminal is configured to provide a time indication pulse signal to a transmission terminal of a slave control circuit; and
when the multi-converter switching power supply operates in the first power supply mode and the integrated control circuit is configured as the salve control circuit, the salve control circuit is configured to receive the time indication pulse signal from the transmission terminal of the master control circuit, and to control the switching converter based on the time indication pulse signal.

10. The integrated control circuit of claim 9, wherein entering the first power supply mode is identified in response to a duration of the logic low state of the enable signal exceeding a first time threshold.

11. The integrated control circuit of claim 9, wherein exiting the first power supply mode is identified in response to the duration of the logic low state of the enable signal exceeding a second time threshold, wherein the second time threshold is longer than the first time threshold.

12. The integrated control circuit of claim 9, wherein:
the integrated control circuit configured as the master control circuit is configured to start timing from a first transition edge of the enable signal after the identification of the first power supply mode, and to provide a first pulse signal when the timing duration reaches a first timing period; and
the integrated control circuit configured as the slave control circuit is configured to start timing from the first transition edge of the enable signal after the identification of the first power supply mode, and to provide a second pulse signal when the timing duration reaches a second timing period longer than the first timing period.

13. The integrated control circuit of claim 9, wherein the integrated control circuit is configured to control a secondary switch at a secondary side of the switching converter.

14. The integrated control circuit of claim 13, further comprising:
a secondary control circuit configured to provide a primary enable signal based on a control signal of controlling the secondary switch;
an isolation circuit having an input terminal configured to receive the primary on enable signal and an output terminal for outputting a synchronous signal electrically isolated from the primary on enable signal; and
a primary control circuit configured to receive the synchronous signal and to provide a primary control signal for controlling a primary switch at a primary side of the switching converter based on the synchronous signal.

15. The integrated control circuit of claim 14, wherein the time indication pulse signal provided by the mater control circuit is configured to have:
a first level width configured to represent a time difference between a start point when the primary switch is turned on and a stop point when a current flowing though the secondary switch crosses zero; and
a switching cycle period configured to represent a time interval between two consecutive start points.

16. A control method used in a multi-converter switching power supply, comprising:
engaging a first integrated control circuit to control a first switching converter to provide a first output voltage to a first output terminal and a second output terminal; and
engaging a second integrated control circuit to control a second switching converter to provide a second output voltage to a third output terminal and a fourth output terminal;
receiving an enable signal having a logic high state and a logic low state, wherein the enable signal indicates that the multi-converter switching power supply operates in a first power supply mode or a second power supply mode;
configuring one of the first integrated control circuit and the second integrated control circuit as a master control circuit and configuring the other of the first integrated control circuit and the second integrated control circuit as a slave control circuit after entering the first power supply mode is identified;
providing a control signal, by the master control circuit, to control the corresponding switching converter based on a feedback signal representing an output voltage of the corresponding converter;
sending a time indication pulse signal at a transmission terminal of the master control circuit to a transmission terminal of the slave control circuit; and
receiving the time indication pulse signal from the mater control circuit, by the slave control circuit, and controlling the switching converter corresponding to the salve control circuit based on the time indication pulse signal.

17. The control method of claim 16, wherein entering the first power supply mode is identified in response to a duration of the logic low state of the enable signal exceeding a first time threshold.

18. The control method of claim 16, wherein:
the configuration of the master control circuit comprising:
starting timing from a first transition edge of the enable signal after the identification of the first power supply mode, and providing a first pulse signal when the timing duration reaches a first timing period; and
the configuration of the slave control circuit comprising:
starting timing from the first transition edge of the enable signal after the identification of the first power supply mode and providing a second pulse signal when the timing duration reaches a second timing period longer than the first timing period.

19. The control method of claim 17, wherein exiting the first power supply mode is identified in response to the duration of the logic low state of the enable signal exceeding a second time threshold longer than the first time threshold.

20. The control method of claim 16, wherein:
when the multi-converter switching power supply operates in the first power supply mode, the first output terminal and the third output terminal are both coupled to a first bus terminal of receiving a first voltage, the first switching converter and the second switching converter are both configured to provide the first voltage to the first bus terminal; and
when the multi-converter switching power supply operates in the second power supply mode, the first output terminal is coupled to the first bus terminal for receiving the first voltage, the third output terminal is coupled to a second bus terminal for receiving a second voltage, the first output voltage is configured as the first voltage, and the second output voltage is configured as the second voltage.

21. The control method of claim 17, wherein the control signal is configured to control a secondary switch at a secondary side of the corresponding switching converter.

22. The control method of claim 21, wherein the time indication pulse signal provided by the mater control circuit is configured to have:
a first level width configured to represent a time difference between a start point when a primary switch is turned on and a stop point when a current flowing though the secondary switch crosses zero; and
a switching cycle period configured to represent a time interval between two consecutive start points.
